(19) United States
(12) Patent Application Publication
(10) Pub. No.: US 2025/0043977 A1
(43) Pub. Date: Feb. 6, 2025

(54) AN AIR FLOW WALL UNIT AND A BUILDING COMPRISING AN AIR FLOW SYSTEM

(71) Applicant: ENERGY FLOW WALL APS, Lunderskov (DK)

(72) Inventor: Poul Christensen HORN, Nordborg (DK)

(21) Appl. No.: 18/717,488

(22) PCT Filed: Dec. 7, 2022
(86) PCT No.: PCT/DK2022/050268

§ 371 Date: Jun. 7, 2024

(30) Foreign Application Priority Data
Dec. 7, 2021 (DK) PA 2021 70601

(51) Int. Cl. F24F 11/00; F24F 5/00; F24F 110/10

(52) U.S. Cl. CPC F24F 11/0001; F24F 5/0021; F24F 2005/0064; F24F 2005/0078; F24F 2110/10

(57) ABSTRACT

An air flow wall unit for providing a heat-treated air flow into a building includes a top part, a bottom part and a heat chamber wherein the bottom part includes an air inlet channel, the top part includes an air flow control valve with a valve inlet, a building outlet, and an exhaust outlet, and the heat chamber includes a Chamber front, and a phase change material unit for heat-treating air, the air flow wall unit further includes a power source powering a controller adapted for changing a state of the air flow control valve between a building air flow state configured for an air flow direction from the heat chamber and out through the building outlet; and a PCM cooling state configured for an air flow between the heat chamber and the exhaust outlet; and a no-flow state.

### CROSS-REFERENCE TO RELATED APPLICATIONS

This application is a national stage of PCT Application No. PCT/DK2022/050268, having a filing date of Dec. 7, 2022, which is based DK Application No. PA 2021 70601, having a filing date of Dec. 7, 2021, the entire contents both of which are hereby incorporated by reference.

### FIELD OF TECHNOLOGY

The following relates to an air flow wall unit for providing a heat-treated air flow into a building. The heat-treatment may be either cooling or heating the air flow prior to introducing the air flow into the building thereby lowering the energy consumption using external energy sources.

### BACKGROUND

Energy consumption of electrical energy and heating/cooling energy for building is a large part of a country's total energy consumption. Different states may have a climate demanding a higher energy consumption for cooling or a higher energy consumption for heating. However, the need for cooling and heating is very dependent on the season, and over a year most buildings will need a combination of cooling and heating.

The need for heating and cooling does not change when the building is a house, a flat or an apartment or a residence or another building.

There is a constant need for lowering a buildings total energy consumption from external energy providers. The energy consumption of the building may not decrease with embodiments of the present invention, but energy sources such as the sun or the ambient atmosphere may be used for heating and/or cooling the building. Besides that, the temperature in the ground is quite stable and can be used for cooling a building.

### SUMMARY

An aspect relates to provide an air flow wall unit which passively, or at least semi-passively, is able to heat-treat air before introducing the heat-treated air into a building.

It is an aspect of embodiments of the invention to provide a building with an air flow system for heating and/or cooling using an air flow wall unit.

An aspect of embodiments of the invention is achieved by an air flow wall unit for providing a heat-treated air flow into a building.

The air flow wall unit comprises a top part, an opposite bottom part and a heat chamber interconnecting the top part and the bottom part, wherein
the bottom part comprises an air inlet channel connected to the heat chamber for intake of ambient air,
the top part comprises an air flow control valve with a valve inlet connected to the heat chamber, a building outlet for providing heat-treated air flow into a building, and an exhaust outlet for exhausting heat-treated air, and
the heat chamber comprises a chamber front extending between the top part and the bottom part, and a phase change material unit extending at least partly between the top part and the bottom part for heat-treating air in the heat chamber.

The air flow wall unit further comprises a power source powering a controller adapted for changing a state of the air flow control valve between
a building air flow state configured for an air flow direction from the heat chamber and out through the building outlet; and
a PCM cooling state configured for an air flow between the heat chamber and the exhaust outlet; and
a no-flow state configured for blocking the valve inlet.

The phase change material unit will either heat or cool the air flowing through the heat chamber as a function of the relative temperature between the phase change material in the phase change material unit and the temperature of the air entering the heat chamber.

The skilled person would be able to select the phase change material depending on respective need for heating or cooling.

The abbreviation “PCM” will in this application be used for phase change material.

The air flow wall unit may as describe change the state of the air flow control valve which change in temperature will directly affect the temperature of the phase change material unit.

When the air flow control valve is in a building air flow state, then the heat energy will transfer between the air and the PCM.

When the air flow control valve is in a building air flow state, then the heat energy will transfer between the air and the PCM.

When the air flow control valve is in a PCM cooling state then the PCM will transfer heat to air which will be exhausted from air flow wall unit. This state will typically be used when the PCM temperature has increased above a threshold temperature thereby preventing overheating of the PCM. The PCM cooling state may also be used in the cases where the air flow wall unit is configured for cooling, and the air flow control valve is in a PCM cooling state during the night and optionally early morning for cooling the PCM material, and the cooled PCM material is then used during the day for providing cooled air.

When the air flow control valve is in a no-flow state configured for blocking the valve inlet, then no air flow will flow through the heat chamber as a consequence. The PCM material will typically either be heated or cooled depending on the overall configuration of the air flow wall unit.

The width of air flow wall unit may be 45 cm or 75 cm or 100 cm or wider.

The valve inlet will typically have an opening along the entire width of the heat chamber which will allow a greater air flow.

The power source may be a connector to building power for providing electric energy to the air flow wall unit.

The phase change material unit may be made of aluminium formed to contain a phase change material. The skilled person would know which PCM to choose depending on the need.

The phase change material unit may be made of a metal.

In an embodiment, the air flow control valve is controllable via the controller by a user using Wifi, Bluetooth or any other near field communication. The controller may be connected to a network using wired or wireless communication.

The air flow wall unit may be enclosed by a frame made of wood and/or a composite material and/or aluminium and/or plastics depending on the need.

The air flow wall unit may be installed on a wall or on a flat roof or a tilted roof. Thus, the air flow wall unit can be installed substantially vertically or horizontally, or at an angle, depending on the need.

In some embodiments the phase change material unit can be attached by clicking the phase change material unit to a back of the heat chamber being opposite to the chamber front, where the back of the heat chamber has means for holding the phase change material unit.

In an aspect of embodiments of the invention, the chamber front may be at least partly permeable of sun light for heating the phase change material unit. Thereby, the air flow wall unit becomes an air flow heating wall unit, as the air flow wall unit is adapted for increasing the temperature of the air before leading the air flow into the building through the building outlet.

The chamber front may be partly permeable of sun light by having glass or a polymer enabling light to enter the heat chamber.

The glass or polymer may be colour graded to control the amount of sun light entering the heat chamber such that heating of the PCM material becomes less extreme. This will decrease the need for the air flow control valve to be in the PCM cooling state, and this will allow for longer periods being in the building air flow state.

The chamber front may substantially be double-glazed window for maximising the heat transfer to the PCM and for isolating the heat chamber.

In an aspect of embodiments of the invention, the chamber front may comprise a solar cell and the power source may be a battery adapted for being charged by the solar cell.

The purpose of the solar cell is to primarily charge the battery and to power the controller and the air flow control valve.

Thus, the solar cell does not need to provide a great power, and the solar cell may only form part of the chamber front while the remaining part of the chamber front is made of glass or polymer which is permeable of sun light to enable heating of the PCM.

In some embodiments the solar cell may further power a ventilation fan forming part of the air flow wall unit or being part of the building for the seldom cases where the air flow must be greater than what may passively be obtained.

In this case, the air flow wall unit should be placed in a position, where sunlight can reach the heat chamber through the chamber front.

In an aspect of embodiments of the invention, the solar cell may be partially permeable of sunlight.

Thereby, a sub-part of the sun spectrum will enter the heating chamber and be used for heating the PCM.

The solar cell may be a transparent or semi-transparent solar cell. The transparent or semi-transparent solar cell may in many cases have a colour tint. However, this is not a technical problem in the present as no persons are to see through the solar cell.

The transparent soler cell may be bought from Heliatek GmbH.

It is well-known that transparent solar cells have a smaller efficiency since the solar cell is transparent, however in the present case this is allowable.

It is expected that the annual power consumption of the air flow control valve and controller is expected to be equivalent of 5 to 6 12V batteries. However, the solar cell may have a larger annual production which can be used to powering a circulation pump or similar products. The solar cell may form part of the energy source for the building.

The transparent or semi-transparent solar cell may be positioned on the inner-most glass of a double-glazed window, where the double-glazed window defines the chamber front. Thereby, the heat generated by the solar cell will to a higher degree be transferred to the heat chamber.

In an aspect, the air flow control valve may further comprise a top outlet for providing airflow to a secondary unit such as an air flow wall unit on a northward side of a building or a ventilation window on a northward side of a building or directly into a room of a building. Thereby, the air flow wall unit can be used to heat the rooms which do not face towards the sun i.e. the unit may heat rooms on the northward side of a building. This is especially useful when the PCM material has reached, or is close to, a maximum operation temperature. It is then possible to increase flow through the air flow wall unit and use it to cool the PCM material while exploiting the heated air for heating rooms on the northward side of a building.

In an aspect of embodiments of the invention, the chamber front may be provided with an insulation layer for preventing heating of the phase change material unit.

The insulation layer will prevent heating of the PCM material as the insulation layer prevent light and the ambient atmosphere outside of the air flow wall unit from heating the PCM material. Thereby, the air flow wall unit becomes an air flow cooling wall unit.

In this case, the air flow wall unit should be placed in a position, where sunlight cannot directly heat the air flow wall unit as this is unwanted, as the air flow wall unit is adapted for cooling the air flowing through the air flow wall unit for cooling the building. This may be achieved by the air flow wall unit being positioned on a northward side of the building.

In an aspect of embodiments of the invention, wherein the air flow wall unit may further comprise a ground cooling unit having one or more tubes in the heat chamber and a coupling unit for connecting with one or more extending into ground.

The ground cooling unit will, when coupled to the ground, be used for cooling the phase change unit, and thus the PCM inside the phase change unit. The ground will have a temperature lower than the temperature of the air to enter the building.

As an example, the ground temperature a few meters below the ground surface in Denmark is approximately 8 degrees Celsius. It is possible to add a heat pump, however this is not a requirement as the 8 degrees Celsius is sufficient and in many areas the ground temperature is sufficient.

In an embodiment the phase change material unit forms one, two or more hollow cylinders, wherein the hollow cylinders extend between the bottom part and the top part.

The hollow cylinders may in some embodiments be fitted one or more tubes along the hollow cylinders or the tubes may be placed in the PCM containers as a part of the containers.

In an aspect of embodiments of the invention, the power source may be a connector to building power and the air flow wall unit further may comprise a pump for circulating cooling liquid through the ground cooling unit.

The air flow control valve is positioned in the top part and the air inlet channel is positioned in the bottom part. It is well-known that hot air rises while cold air drops, thus the pump will ensure that air flows into the building. In some embodiments this is not needed as the building can suck air into building using means inside the building or the updrift from air inside the heat chamber having an increased temperature thereby causing an updrift due to buoyancy forces.

In an embodiment, the air flow wall unit may further comprise a house heating unit having one or more tubes in the heat chamber and a coupling unit for connecting with one or more tubes extending in the building for heating of the building or to a buffer container for later use of the heated.

The house heating unit and the ground cooling unit may be the same kind of unit and the functioning is defined by the positioning of the air flow wall unit and the connection to external units.

For the embodiments with a house heating unit or a ground cooling unit the one or more tubes may be integrated into the phase change material unit such that the distance between the tubes and the phase change material is minimised which thereby increases the efficiency of heat transfer.

For both the house heating unit and the ground cooling unit, the one or more tubes may form a single line or a plurality of lines using a manifold. The temperature of the single line configuration will be higher than the plurality of lines, however the total flow will be lower, and this decreases the heat transfer capacity. The plurality of lines and a manifold will increase the liquid flow and the heat transfer capacity, and if the liquid is stored in a separate storage tank, then the tank will empty more quickly, however the temperature level of the liquid will be lower.

In the case, where the house heating unit must be used for floor heating with water as the transfer medium in the one or more tubes, then it is recommended to use a single line as this will give the highest temperature.

In an aspect of embodiments of the invention, the air flow wall unit may comprise a temperature sensor connected to the controller, wherein the state of the air flow control valve is changed as a function of the temperature sensor.

The functioning of the air flow wall unit is greatly dependent on the temperature. Thus, the temperature sensor enables the controller to increase the effectiveness of the air flow wall unit.

Furthermore, in an embodiment the temperature sensor may measure the temperature of the PCM or the phase change material unit as the temperature of the PCM has great impact on the performance of the air flow wall unit.

In an aspect, the chamber front may be provided with an insulation layer for preventing heat exchange of the phase change material unit, and wherein the insulation layer is connected to a rail so that the insulation layer can be displaced between a first position, wherein the insulation is in front of the phase change material unit and a second position, wherein the phase change material unit is not insulated. Thereby, heated PCM material can be stored for a longer amount of time into the night by insulating the front after sundown. Thereby the PCM may provide more heating to the house. Likewise, the cooled PCM material may be cooled faster by removing the insulation layer so that more and/or faster cooling of the air can be performed.

In an aspect, the chamber front may be provided with an insulation layer for preventing heat exchange of the phase change material unit, and wherein the air flow wall unit comprises a roller connected to the insulation layer and adapted for winding and unwinding the insulation layer. The insulation layer sides may follow tracks so that the winding and unwinding is performed in a controlled way. Thereby, heated PCM material can be stored for a longer amount of time into the night by insulating the front after sundown and thereby the PCM may provide more heating to the house. Likewise, the cooled PCM material may be cooled faster by removing the insulation layer so that more and/or faster cooling of the air can be performed.

In an aspect, the air flow control valve may further be configured to enable airflow between the building outlet and the exhaust outlet. Thereby, it becomes possible to bypass the PCM material which can be required if heat treatment is unwanted.

An aspect of embodiments of the invention is achieved by building comprising an air flow system for providing a heat-treated air flow into the building. The air flow system comprises
a first air flow wall unit as described in one or more earlier embodiments configured for heating the building, the first air flow wall unit being installed on east-west- or southward side of the building; and/or
a second air flow wall unit as described in one or more earlier embodiments configured for cooling the building, the second air flow wall unit being installed on northward side of the building.

The building may in an embodiment be fitted with the first air flow wall unit configured for heating the building. Thereby energy costs for heating building can be reduced.

The skilled person would know that depending on the size of the building, the building may be fitted with two or more of first air flow wall units configured for heating the building.

The first air flow wall unit can be positioned on the east-west- or southward side of the building, however in most cases the effect of the first air flow wall will be greatest when positioned on the southward side of the building due to time in sun light.

The building may in an embodiment be fitted with the second air flow wall configured for cooling the building. Thereby energy costs for cooling the building can be reduced.

The skilled person would know that depending on the size of the building, the building may be fitted with two or more of second air flow wall units configured for cooling the building.

When the building is a flat, an apartment or a regular house then the first air flow wall unit and/or the second air flow wall unit will in many cases be sufficient.

The greatest reduction in yearly energy consumption of power and/or heating is achieved when the building is fitted with the first air flow wall unit and the second air flow wall unit. Calculations estimate that a Danish BR2020 house under optimal condition can save more than 40% in heating/cooling using a flow wall system.

A Danish BR2020 house is well insulated and thus the savings for a house with worse insulation qualities than a Danish BR2020 house will have an even greater effect than just 40%.

In an aspect of embodiments of the invention, the controllers of the first air flow wall unit and the second air flow wall unit are configured for communication with a building control system, and wherein the controllers are configured to change the state of the air flow control valves as function of data received from the building control system.

Thereby, the first air flow wall unit and the second air flow wall unit as a system which will increase the efficiency of the air flow system.

In an aspect, the first air flow wall unit further comprises a top outlet which is connected via an airflow connection to a ventilation window on the northward side of the building or to the second air flow wall unit or to another room of a building wherein this room is not directly connected to the building outlet. Thereby heat from the first air flow wall unit can be used to heat rooms on the northward facing side of a building as previously described.

### BRIEF DESCRIPTION

Some of the embodiments will be described in detail, with references to the following Figures, wherein like designations denote like members, wherein:

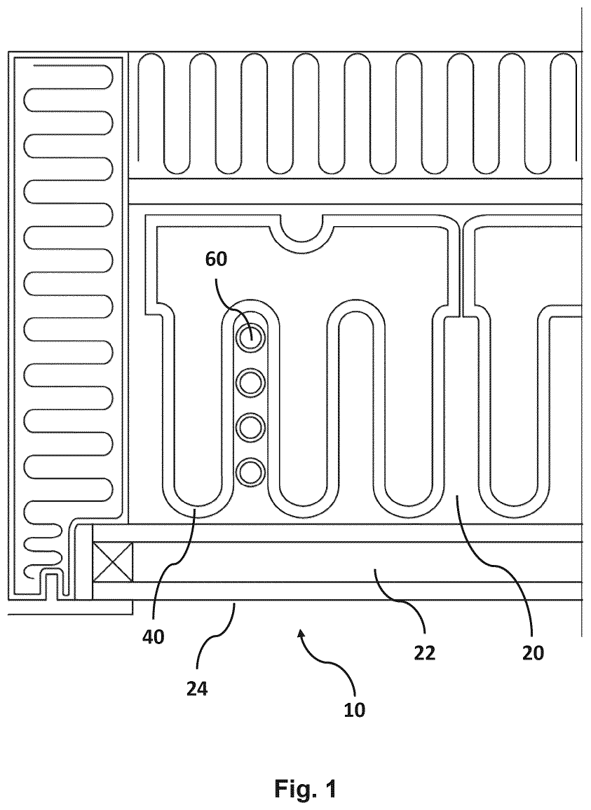

FIG. 1 illustrates a horizontal cross-section view of an air flow wall unit;

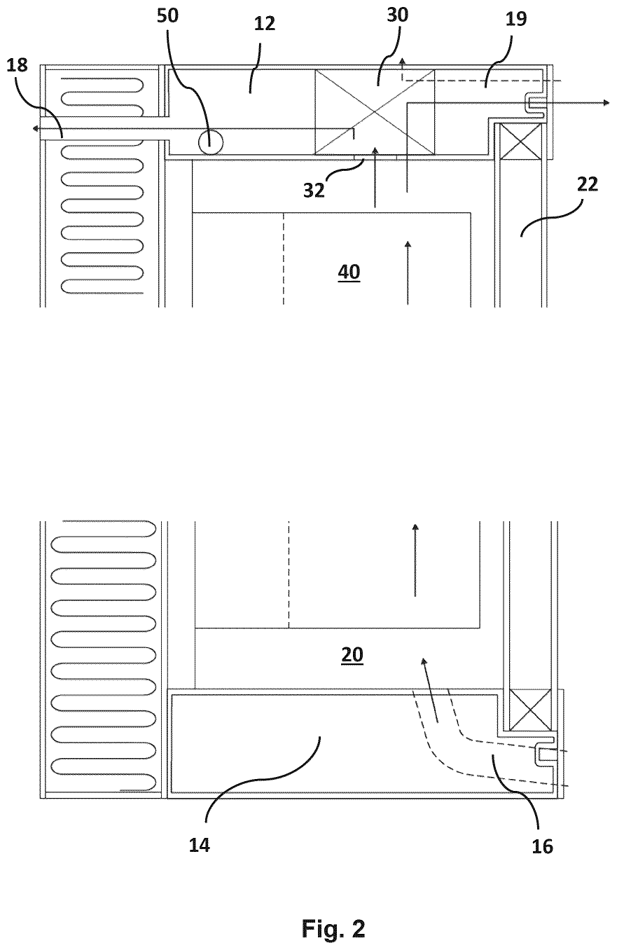

FIG. 2 illustrates a vertical cross-section view of the air flow wall unit in FIG. 1;

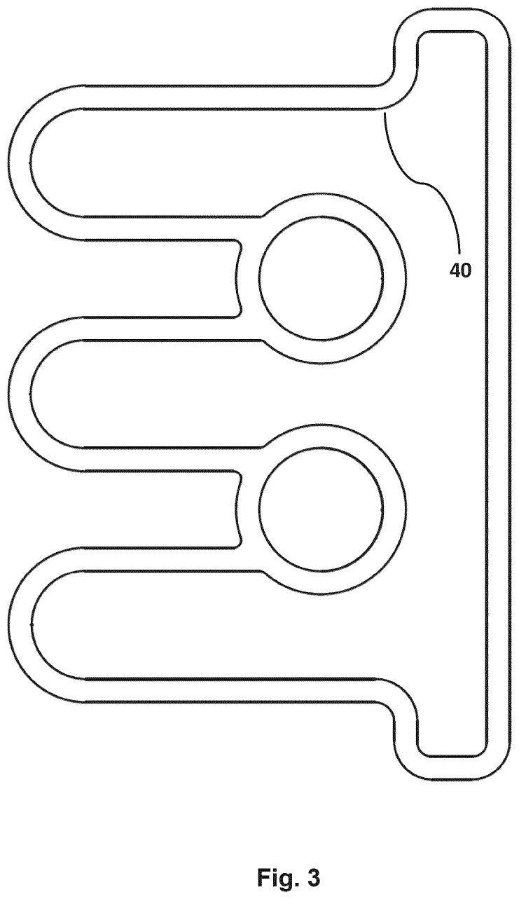

FIG. 3 illustrates a cross-section view of a phase change material unit; and

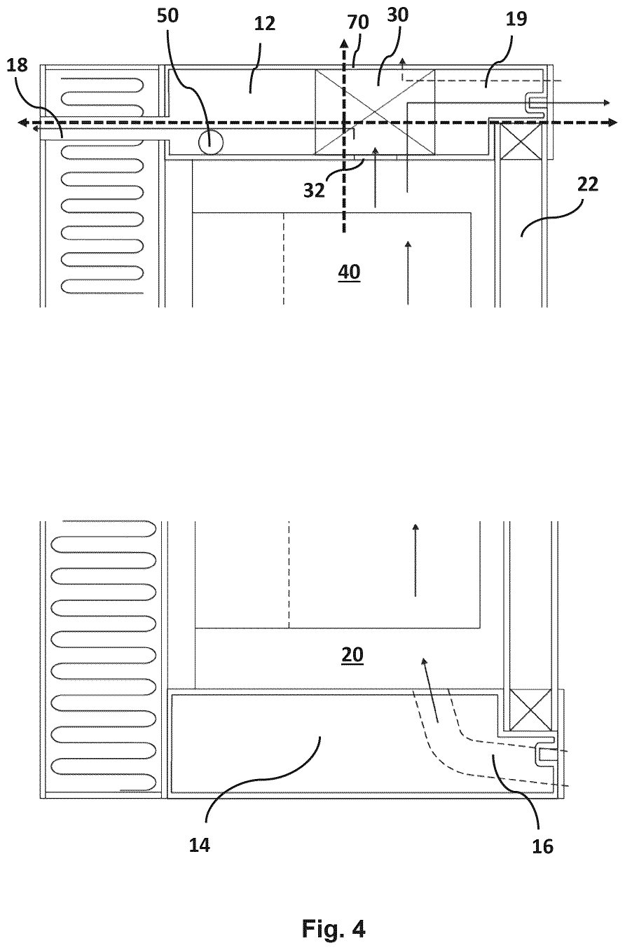

FIG. 4 illustrates a vertical cross-section view of the air flow wall unit in FIG. 1 further including a top outlet.

| Item | Reference |
|---|---|
| Air flow wall unit | 10 |
| Top part | 12 |
| Bottom part | 14 |
| Air inlet channel | 16 |
| Building outlet | 18 |
| Exhaust outlet | 19 |
| Heat chamber | 20 |
| Chamber front | 22 |
| Solar cell | 24 |
| Air flow control valve | 30 |
| Valve inlet | 32 |
| Phase change material unit | 40 |
| Battery | 50 |
| Tubes | 60 |
| Top outlet | 70 |

### DETAILED DESCRIPTION

FIG. 1 illustrates a first cross-section view of an air flow wall unit 10 and FIG. 2 illustrates a second cross-section view of the air flow wall unit 10 in FIG. 1. The air flow wall unit 10 comprises a top part 12, an opposite bottom part 14 and a heat chamber 20 interconnecting the top part 12 and the bottom part 14, where air flowing from the bottom part 14 to the top part 12 will be heat-treated while flowing through the heat chamber 20. The heat-treatment of the air may result in the air temperature rising or falling depending on relative temperatures between the air and the heat chamber.

The bottom part 14 comprises an air inlet channel 16 connected to the heat chamber 20 for intake of ambient air into the heat chamber 20. The air inlet channel 16 may extending along the entire bottom part or having a width equal or at least similar to the width of the heat chamber.

The top part 12 comprises an air flow control valve 30 with a valve inlet 32 connected to the heat chamber 20, a building outlet 18 for providing heat-treated air flow into a building, and an exhaust outlet 19 for exhausting heat-treated air.

The air flow control valve 30 may in addition have a ventilation window inlet for providing an air flow to a ventilation window. This is illustrated by the dotted arrow in FIG. 2 in the upper part of the top part 12.

The heat chamber 20 comprises a chamber front 22 extending between the top part 12 and the bottom part 14, and a phase change material unit 40 extending at least partly between the top part 12 and the bottom part 14 for heat-treating air in the heat chamber 20.

In the shown embodiment the chamber front 22 is a double-glazed window, and thus the shown air flow wall unit 10 is designed to increase the temperature of the air flowing through the heat chamber 20. In other embodiments the chamber front 22 may be insulated to prevent heating of the heat chamber 20 by sun light or similar means.

The phase change material unit 40 can be accessed and replaced through the chamber front 22 and in some embodiments the phase change material unit 40 can be attached by clicking the phase change material unit 40 to the back of the heat chamber 20.

The double-glazed window could be fitted with a transparent solar cell.

The air flow wall unit 10 further comprises a power source in the form of a battery 50 powering a controller adapted for changing a state of the air flow control valve 30 between
a building air flow state configured for an air flow direction from the heat chamber 20 and out through the building outlet 18; and
a PCM cooling state configured for an air flow between the heat chamber 20 and the exhaust outlet 19; and
a no-flow state configured for blocking the valve inlet 32.

The air flow is illustrated in FIG. 2 by straight solid arrows.

The FIG. 1 embodiment has tubes filed a liquid extending next to the phase change material unit 40. The purpose of the tubes 60 is to cool the phase change material inside the phase change material unit 40, where the temperature of the liquid inside the tubes 60 will increase and as a result the liquid can be used to heat parts of the building.

FIG. 3 illustrates a cross-section view of a phase change material unit 40. The phase change material unit 40 form two cylinders where each can be fitted with tubes 60 (not shown), a single tube with the same diameter as the cylinder or the cylinder is used as a tube, where liquid is to flow through the tube with the purpose of either heating or cooling the phase change material unit 40.

FIG. 4 illustrates a vertical cross-section view of the air flow wall unit 10 in FIGS. 1 and 2, wherein the air flow wall unit 10 further includes a top outlet 70 for providing airflow to a secondary unit such as an air flow wall unit 10 on a northward side of a building or a ventilation window on a northward side of a building or to another room of the building not directly connected to the building outlet 18.

The figure further discloses a dashed double arrow illustrating the possible airflow between the building outlet 18 and the exhaust outlet 19.

The figure further discloses a dashed vertical arrow illustrating airflow through the top outlet.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An air flow wall unit for providing a heat-treated air flow into a building, the air flow wall unit comprising: a top part, an opposite bottom part, and a heat chamber interconnecting the top part and the bottom part, wherein
the bottom part includes an air inlet channel connected to the heat chamber for intake of ambient air,
the top part includes an air flow control valve with a valve inlet connected to the heat chamber, a building outlet for providing heat-treated air flow into a building, and an exhaust outlet for exhausting heat-treated air, and
the heat chamber includes a chamber front extending between the top part and the bottom part, and a phase change material unit extending at least partly between the top part and the bottom part for heat-treating air in the heat chamber, and
wherein the air flow wall unit further comprises a power source powering a controller configured for changing a state of the air flow control valve between
a building air flow state configured for an air flow direction from the heat chamber and out through the building outlet; and
a PCM cooling state configured for an air flow between the heat chamber and the exhaust outlet; and
a no-flow state configured for blocking the valve inlet.

2. The air flow wall unit according to claim 1, wherein the chamber front is at least partly permeable of sun light for heating the phase change material unit.

3. The air flow wall unit according to claim 2, wherein the chamber front comprises a solar cell and the power source is a battery configured for being charged by the solar cell.

4. The air flow wall unit according to claim 3, wherein the solar cell is partially permeable of sunlight.

5. The air flow wall unit according to claim 1, wherein the air flow control valve further comprises a top outlet for providing airflow to a secondary unit such as an air flow wall unit on a northward side of a building or a ventilation window on a northward side of a building or another room of a building.

6. The air flow wall unit according to claim 1, wherein the chamber front is provided with an insulation layer for preventing heating of the phase change material unit.

7. The air flow wall unit according to claim 6, wherein the air flow wall unit further comprises a ground cooling unit having one or more tubes in the heat chamber and a coupling unit for connecting with one or more tubes extending into ground.

8. The air flow wall unit according to claim 7, wherein the power source is a connector to building power and the air flow wall unit further comprises a pump for circulating cooling liquid through the ground cooling unit.

9. The air flow wall unit according to claim 1, wherein the air flow wall unit comprises a temperature sensor connected to the controller, wherein the state of the air flow control valve is changed as a function of the temperature sensor.

10. The air flow wall unit according to claim 1, wherein the chamber front is provided with an insulation layer for preventing heat exchange of the phase change material unit, and
wherein the insulation layer is connected to a rail so that the insulation layer can be displaced between a first position, wherein the insulation is in front of the phase change material unit and a second position, wherein the phase change material unit is not insulated; or
wherein the air flow wall unit comprises a roller connected to the insulation layer and configured for winding and unwinding the insulation layer.

11. The air flow wall unit according to claim 1, wherein the air flow control valve is further configured to enable airflow between the building outlet and the exhaust outlet.

12. A building comprising an air flow system for providing a heat-treated air flow into the building, the air flow system including
a first air flow wall unit according to claim 2 configured for heating the building, the first air flow wall unit being installed on east- west- or southward side of the building; and/or
a second air flow wall unit configured for cooling the building, the second air flow wall unit being installed on northward side of the building.

13. The building according to claim 12, wherein the controllers of the first air flow wall unit and the second air flow wall unit are configured for communication with a building control system, and wherein the controllers are configured to change the state of the air flow control valves as function of data received from the building control system.

14. The building according to claim 12, wherein the first air flow wall unit further comprises a top outlet and wherein the top outlet is connected via an airflow connection to a ventilation window on the northward side of the building or to the second air flow wall unit or another room of the building.
